(19) United States
(12) Patent Application Publication
(10) Pub. No.: US 2008/0066352 A1
(43) Pub. Date: Mar. 20, 2008

(54) System for displaying photographs

(76) Inventors: Dale Valvo, Bedford, NH (US); Peter Ivas, Penacook, NH (US)

Correspondence Address: DEVINE, MILLIMET & BRANCH, P.A., 111 AMHERST STREET, BOX 719, MANCHESTER, NH, 03105, US

(21) Appl. No.: 11/901,099

(22) Filed: Sep. 14, 2007

Related U.S. Application Data
(60) Provisional application No. 60/844,451, filed on Sep. 14, 2006.

(51) Int. Cl. G09F 1/06

(52) U.S. Cl. 40/124.15

(57) ABSTRACT

A treated sheet of paper on which photographs can be printed that can be folded and assembled into a three-dimensional shape to yield a free-standing display of the photographs.

### CROSS-REFERENCE TO RELATED APPLICATIONS

The present application claims the benefit of provisional patent application Ser. No. 60/844,451, filed Sep. 14, 2006, which is incorporated herein by reference.

### TECHNICAL FIELD

The present invention relates to a display system. More specifically, it relates to a method and apparatus for displaying photographs and other printable images.

### BACKGROUND OF THE INVENTION

The recent proliferation of digital cameras has been followed by a proliferation of means to print digital photographs. Such photographs, as well as ones on film, can be printed, “while-you-wait,” at retail stores, mall kiosks, photographic booths, and the increasingly ubiquitous home printer.

This phenomenon has, in turn, lead to an ever increasing number of photographs relegated to drawers, cabinets and attics for want of a convenient inexpensive means to display them.

### SUMMARY

A preferred embodiment of the present invention includes a sheet of paper, or similar material, in a rectangular shape or other shape readily accepted by photographic printers. The sheet of paper is treated on its first side so that photographs may be printed on it. The second side of the sheet of paper is coated with an adhesive and then covered by a thin covering to protect the adhesive until use.

The sheet of paper is divided by perforations into a first section, including multiple connected facets, six in this embodiment, separated by fold lines and one or more tabs connected to each facet, and a second section that maybe removed and discarded. One or more of the tabs are non-removable and one or more of the tabs are removable such that removing a removable tab also removes the thin covering on the adhesive on the facet to which the tab is connected.

After one or more photographs, or other images, are printed on the first side of one or more of the facets, the second section is removed and discarded. The removable tabs are removed exposing the adhesive on the second side of the facets to which the removable tabs are connected. The first section is then folded to create a three-dimensional shape, a cube in this embodiment, to display the photographs printed on the first side of one or more of the facets. Each of the non-removable tabs is then bent and the first side of the tab is adhered to the exposed adhesive on the second side of a facet, thereby creating a display of photographs.

It is to be understood that other embodiments of the system for displaying photographs of the present invention can be used to display images other than photographs and can be configured to create three-dimensional shapes other than cubes.

### BRIEF DESCRIPTION OF THE DRAWINGS

These and other features and advantages of the present invention will be better understood by reading the following detailed description, taken together with the drawings wherein:

FIG. 1 is a view of the first side of a preferred embodiment of the present invention in an unseparated and unfolded or flat state;

FIG. 2. is a view of the second side of a preferred embodiment of the present invention in an unseparated and unfolded or flat state;

FIG. 3 is a view of the second side of a preferred embodiment of the present invention with the first section separated from the second section;

FIG. 4. is a view of the second side of the first section of a preferred embodiment of the present invention;

FIG. 5. is a pictorial view of the first section of a preferred embodiment of the present invention in a partially folded state; and

FIG. 6. is a pictorial view of the first section of a preferred embodiment of the present invention is a fully folded state.

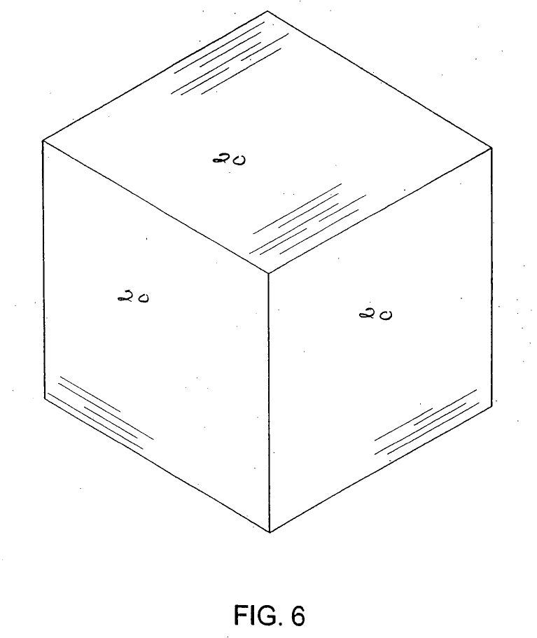

### DETAILED DESCRIPTION OF PREFERRED EMBODIMENTS

The display system of the present invention is a sheet of paper, which term is used herein to include fiberboard or other material on which photographs or other images can be printed, that can then be folded and assembled into a three-dimensional shape to yield a free standing display of photographs or other images printed thereon.

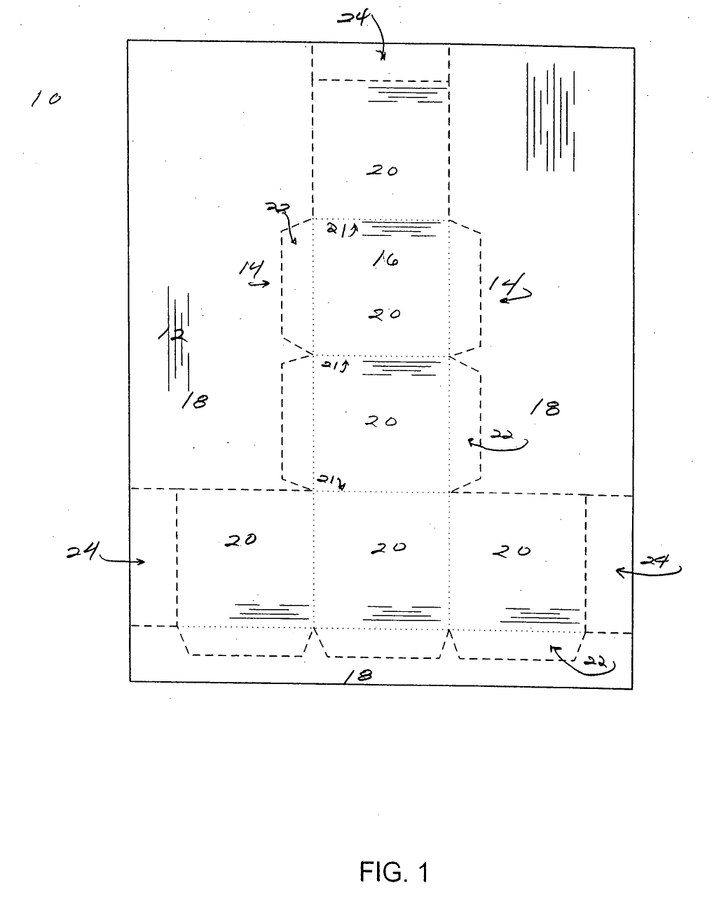

Referring to FIG. 1, a preferred embodiment of the display system of the present invention comprises a sheet of paper 10 in a rectangular shape or other shape readily accepted by photographic printers. The sheet of paper 10 is treated on its first side 12 so that photographs may be printed on it.

The sheet of paper 10 is divided by perforations 14 into a first section 16 and a second section 18. The first section 16 is comprised of multiple connected facets 20 separated by fold lines 21, six in this embodiment, and one or more tabs connected to each facet 20. It should be noted that in other embodiments, the one or more tabs are connected to each of at least two facets. One or more of the tabs are non-removable tabs 22 and one or more of the tabs are removable tabs 24. The second section 18 is removably attached to the first section 16 by the perforations 14 and may be removed and discarded.

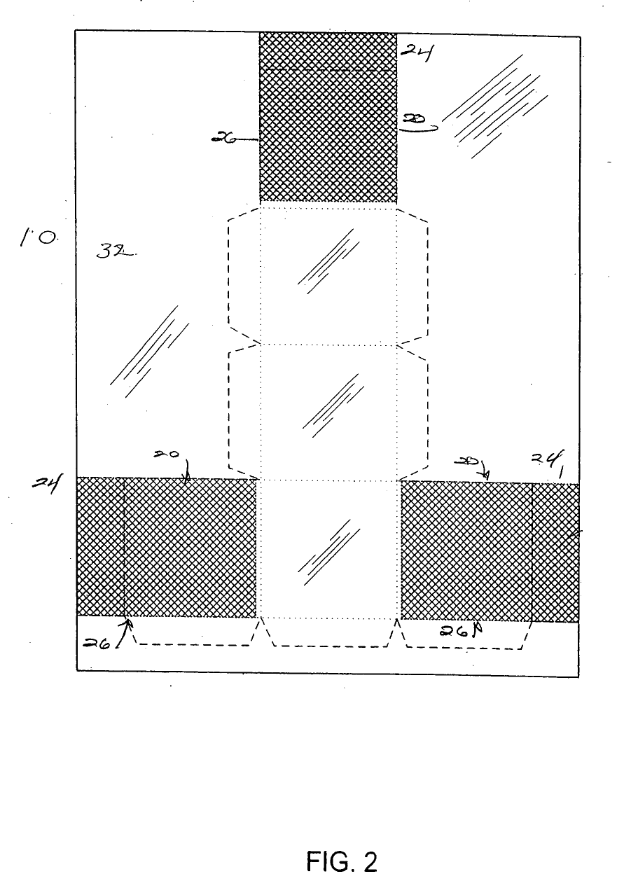

Referring to FIG. 2, the second side 32 of the sheet of paper 10 is shown. The second side 32 is coated with an adhesive and then covered by a thin covering to protect the adhesive until use. One or more of the removable tabs 24 and the facets 20 to which they are connected are covered by portions 26 of the thin covering that are removed when the removable tabs 24 are removed.

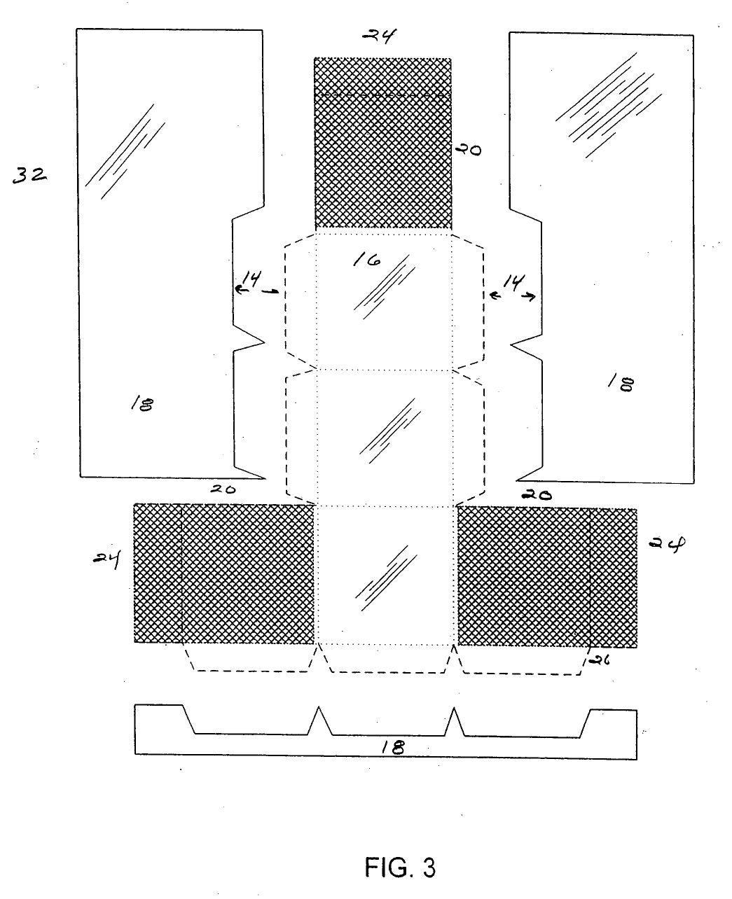

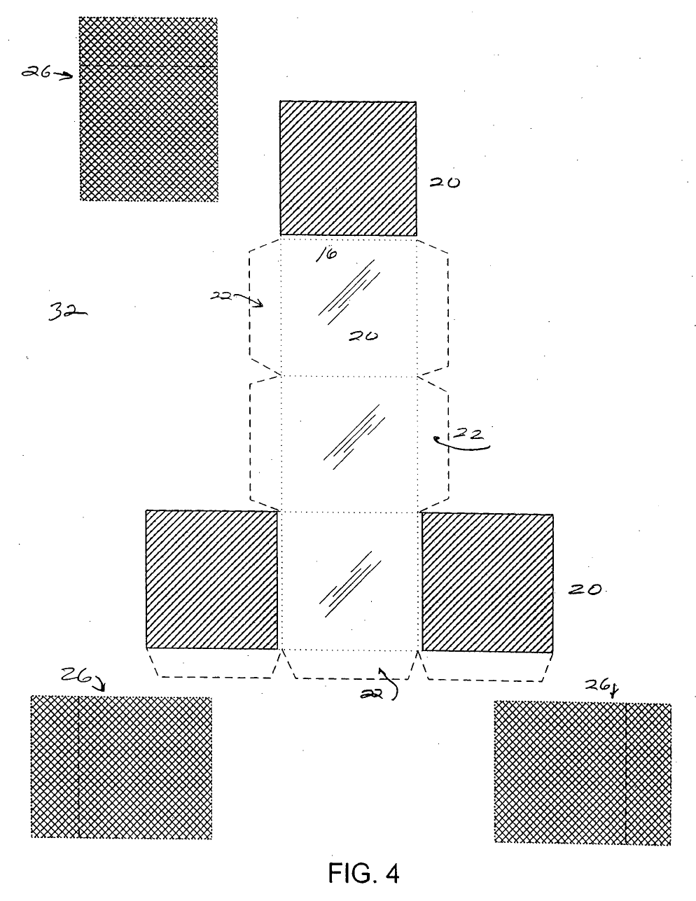

Referring to FIG. 1, showing the first side 12, one or more photographs, or other images, are printed on the first side of one or more of the facets 20 of the first section 16. Referring to FIG. 3, showing the second side 32, the first section 16 is separated from the second section 18 along the perforations 14. The removable tabs 24 are then removed and the portions 26 of the thin sheet covering the removable tabs 24 and the facets 20 to which they are connected is removed. The result, referring to FIG. 4 showing the second side 32, is the first section 16 with facets 20 and non-removable tabs 22. One or more of the facets 20 are coated with an adhesive on which a portion 26 of the thin covering has been removed.

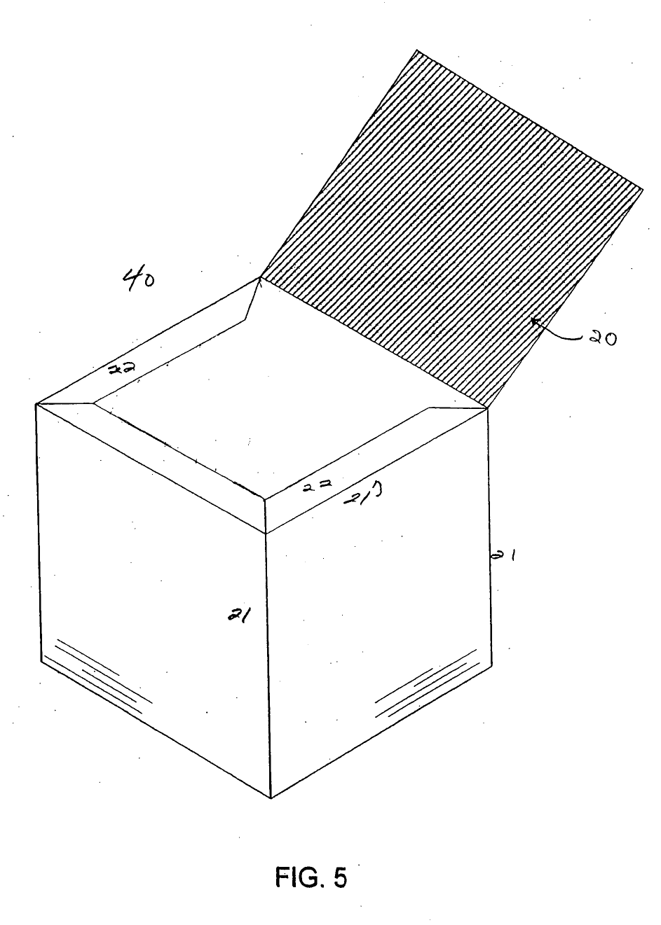

Referring next to FIG. 5, the first section 16 is folded along fold lines 21 to create a three-dimensional shape 40 so that the first side 12 is the exterior of the shape 40 and the second side 32 is the interior of the shape 40. The non-removable tabs 22 are folded so that the first sides of the non-removable tabs 22 adhere to the exposed adhesive on the second side of the facets

In this embodiment, the three-dimensional shape 40 is a cube. The cube displays the photographs printed on the first side of one or more of the facets 20.

It is to be understood that when used herein, the term photographs includes photographs, logos, pictures, drawings, designs, writings or any other desired image. Also, any number of facets can include any number of photographs.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A system for displaying photographs comprising,
a sheet of paper with a first side treated so that photographs may be printed on it and a second side coated with an adhesive and then covered by a thin covering to protect the adhesive until use,
the sheet of paper further divided by perforations into a first section, with multiple connected facets separated by fold lines wherein one or more photographs are printed on the first side of one or more of the facets, and one or more tabs connected to each of at least two facets, and a second section to be removed and discarded,
the tabs further comprising one or more non-removable tabs and one or more removable tabs wherein removing a removable tab removes the thin covering on the second side of the facet to which the removable tab is connected, and
the first section further folded to create a three-dimensional shape to display the one or more photographs printed on the first side of one or more facets and each of the non-removable tabs bent and its first side adhered to the exposed adhesive on the second side of a facet.

2. The system of claim 1 wherein the sheet of paper is in a rectangular shape or other shape readily accepted by photographic printers.

3. The system of claim 1 wherein the multiple connected facets are four facets and the three-dimensional shape is a pyramid.

4. The system of claim 1 wherein the multiple connected facets are six facets and the three-dimensional shape is a cube.

5. A system for displaying photographs comprising,
a sheet of paper with a first side treated so that photographs may be printed on it and a second side coated with an adhesive and then covered by a thin covering to protect the adhesive until use,
the sheet of paper further divided by perforations into a first section, with multiple connected facets separated by fold lines wherein one or more photographs are printed on the first side of one or more of the facets, and one or more tabs connected to each of at least two facets, and a second section to be removed and discarded, and
the tabs further comprising one or more non-removable tabs and one or more removable tabs wherein removing a removable tab removes the thin covering on the second side of the facet to which the removable tab is connected.

6. A method for displaying photographs comprising,
treating a first side of a sheet of paper so that photographs may be printed on it and coating a second side of the sheet of paper with an adhesive and then covering the adhesive by a thin covering to protect the adhesive until use,
dividing the sheet of paper with perforations into a first section, with multiple connected facets separated by fold lines wherein one or more photographs are printed on the first side of one or more of the facets, and one or more tabs connected to each of at least two facets, and a second section to be removed and discarded,
wherein the tabs further comprise one or more non-removable tabs and one or more removable tabs such that removing a removable tab removes the thin covering on the second side of the facet to which the removable tab is connected, and
folding the first section to create a three-dimensional shape to display the one or more photographs printed on the first side of one or more facets and bending each of the non-removable tabs and adhering its first side to the exposed adhesive on the second side of a facet.

7. The method of claim 6 wherein the multiple connected facets are four facets and the three-dimensional shape is a pyramid.

8. The method of claim 6 wherein the multiple connected facets are six facets and the three-dimensional shape is a cube.
